(19) United States
(12) Patent Application Publication
(10) Pub. No.: US 2025/0155650 A1
(43) Pub. Date: May 15, 2025

(54) MULTI-FIBER OPTICAL CONNECTOR AND OPTICAL CONNECTION STRUCTURE

(71) Applicant: Fujikura Ltd., Tokyo (JP)

(72) Inventor: Shuhei KANNO, Sakura-shi, Chiba (JP)

(73) Assignee: Fujikura Ltd., Tokyo (JP)

(21) Appl. No.: 18/834,422

(22) PCT Filed: Aug. 22, 2022
(86) PCT No.: PCT/JP2022/031536

§ 371 Date: Jul. 30, 2024

(30) Foreign Application Priority Data
Feb. 17, 2022 (JP) 2022-022852

(51) Int. Cl. G02B 6/38

(52) U.S. Cl. CPC G02B 6/3839; G02B 6/381; G02B 6/3869; G02B 6/3874; G02B 6/3882

(57) ABSTRACT

A multi-fiber optical connector includes: a ferrule that includes a connection end provided with a connection end surface, a base end located on a side opposite to the connection end, and a plurality of fiber holes through which a plurality of optical fibers are insertable toward the connection end surface; a first member that is disposed to face the base end of the ferrule in a longitudinal direction in which the fiber holes extend; a biasing member that is disposed between the first member and the ferrule in the longitudinal direction, and biases the ferrule toward the connection end; and a spring push that presses the first member toward the connection end via rotational movement.

### TECHNICAL FIELD

The present invention relates to a multi-fiber optical connector and an optical connection structure.

Priority is claimed on Japanese Patent Application No. 2022-022852, filed Feb. 17, 2022, the content of which is incorporated herein by reference.

### BACKGROUND ART

In the related art, a multi-fiber optical connector that accommodates a plurality of optical fibers is known (refer to, for example, Patent Document 1). Such an optical connector generally includes a biasing member that biases a ferrule including a connection end surface toward another optical connector. The connection end surfaces of the optical connector are pushed against each other by the biasing force, so that connection of the optical connector is stable. In a case of performing the connection, a user pushes the connection end surfaces of the optical connectors against each other against the biasing force of the biasing member.

### CITATION LIST

### Patent Document

### [Patent Document 1]

Japanese Unexamined Patent Application, First Publication No. 2019-132929

### SUMMARY OF INVENTION

### Technical Problem

Meanwhile, with the recent improvement in the speed of the network, it is desired to accommodate more optical fibers in one optical connector. In a case where the number of the optical fibers included in the optical connector is increased, the biasing force required to stabilize the connection of the optical connector is increased. In this case, a force that the user should apply when connecting the optical connector may increase, and the difficulty of the connection work may increase.

The present invention has been made in consideration of such circumstances, and an object of the present invention is to provide a multi-fiber optical connector and an optical connection structure with which it is possible to reduce a force required when connecting the multi-fiber optical connectors to each other.

### Solution to Problem

In order to solve the above-described problems, a multi-fiber optical connector according to an aspect of the present invention includes: a ferrule that includes a connection end provided with a connection end surface, a base end located on a side opposite to the connection end, and a plurality of fiber holes through which a plurality of optical fibers are insertable toward the connection end surface; a first member that is disposed to face the base end of the ferrule in a longitudinal direction in which the fiber holes extend; a biasing member that is disposed between the first member and the ferrule in the longitudinal direction, and biases the ferrule toward the connection end; and a spring push that presses the first member toward the connection end via rotational movement.

In order to solve the above-described problems, a multi-fiber optical connector according to an aspect of the present invention is inserted into an adapter, the multi-fiber optical connector includes: a ferrule that includes a connection end provided with a connection end surface, a base end located on a side opposite to the connection end, and a plurality of fiber holes through which a plurality of optical fibers are insertable toward the connection end surface; a first member that is disposed to face the base end of the ferrule in a longitudinal direction in which the fiber holes extend; a biasing member that is disposed between the first member and the ferrule in the longitudinal direction, and biases the ferrule toward the connection end; and a spring push that presses the first member toward the connection end via rotational movement.

### Advantageous Effects of Invention

According to the above-described aspects of the present invention, it is possible to provide a multi-fiber optical connector and an optical connection structure with which a force required when connecting multi-fiber optical connectors to each other can be reduced.

### BRIEF DESCRIPTION OF DRAWINGS

FIG. 1 is a perspective view showing an optical connection structure according to an embodiment of the present invention.

FIG. 2 is a cross-sectional view taken along a line II-II in FIG. 1.

FIG. 3 is a perspective view showing a multi-fiber optical connector according to the embodiment of the present invention.

FIG. 4 is an exploded view showing a part of the multi-fiber optical connector according to the embodiment of the present invention.

FIG. 5 is a diagram showing a first member according to the embodiment of the present invention.

FIG. 6 is a perspective view showing a spring push according to the embodiment of the present invention.

FIG. 7A is a perspective view showing an adapter according to the embodiment of the present invention.

FIG. 7B is a diagram of the adapter shown in FIG. 7A as viewed from an arrow VIIB.

FIG. 7C is a diagram of the adapter shown in FIG. 7A as viewed from an arrow VIIC.

FIG. 7D is a diagram of the adapter shown in FIG. 7A as viewed from an arrow VIID.

FIG. 7E is a diagram of the adapter shown in FIG. 7A as viewed from an arrow VIIE.

FIG. 7F is a diagram of the adapter shown in FIG. 7A as viewed from an arrow VIIF.

FIG. 7G is a diagram of the adapter shown in FIG. 7A as viewed from an arrow VIIG.

FIG. 8 is a diagram of the optical connection structure shown in FIG. 1 as viewed from the arrow VIII.

FIG. 9A is a diagram showing a state in which a biasing member according to the embodiment of the present invention is interposed between the first member and a second member.

FIG. 9B is a diagram showing a state subsequent to FIG. 9A.

FIG. 10A is a diagram showing a state in which the multi-fiber optical connector according to the embodiment of the present invention is inserted into the adapter.

FIG. 10B is a diagram showing a state subsequent to FIG. 10A.

FIG. 11 is a diagram showing a state in which the optical connection structures according to the embodiment of the present invention are two-dimensionally arranged.

### DESCRIPTION OF EMBODIMENTS

Hereinafter, a multi-fiber optical connector 1 and an optical connection structure 100 according to an embodiment of the present invention will be described with reference to the accompanying drawings.

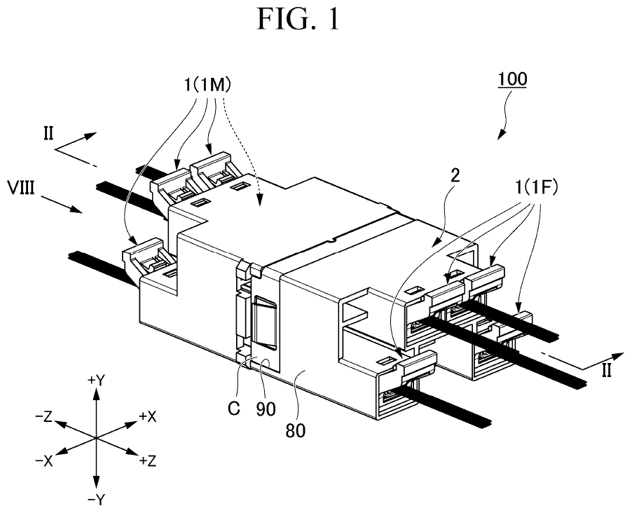

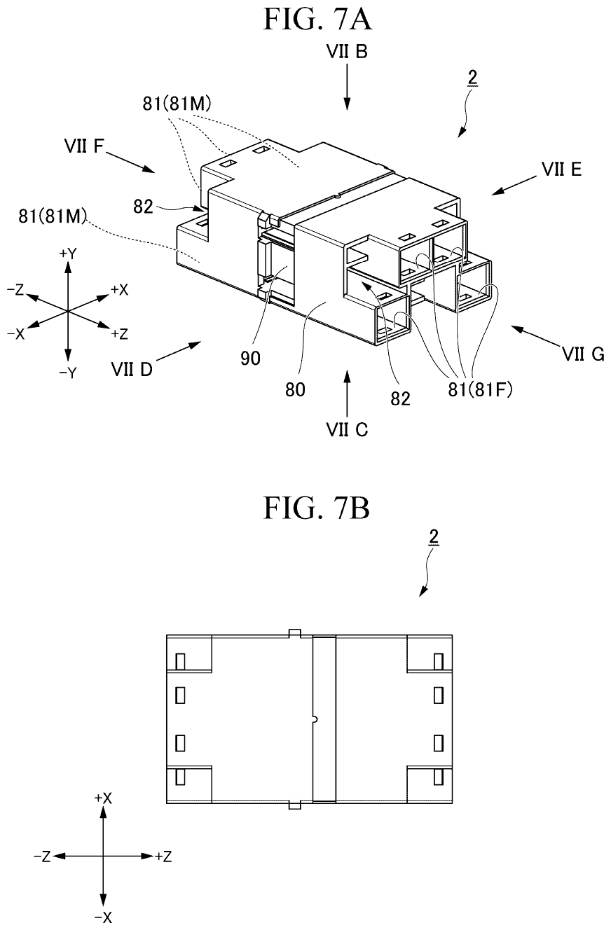

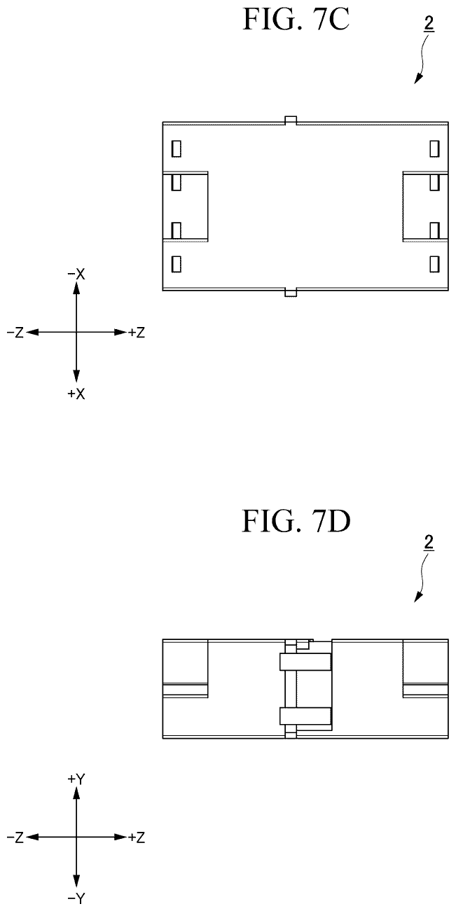

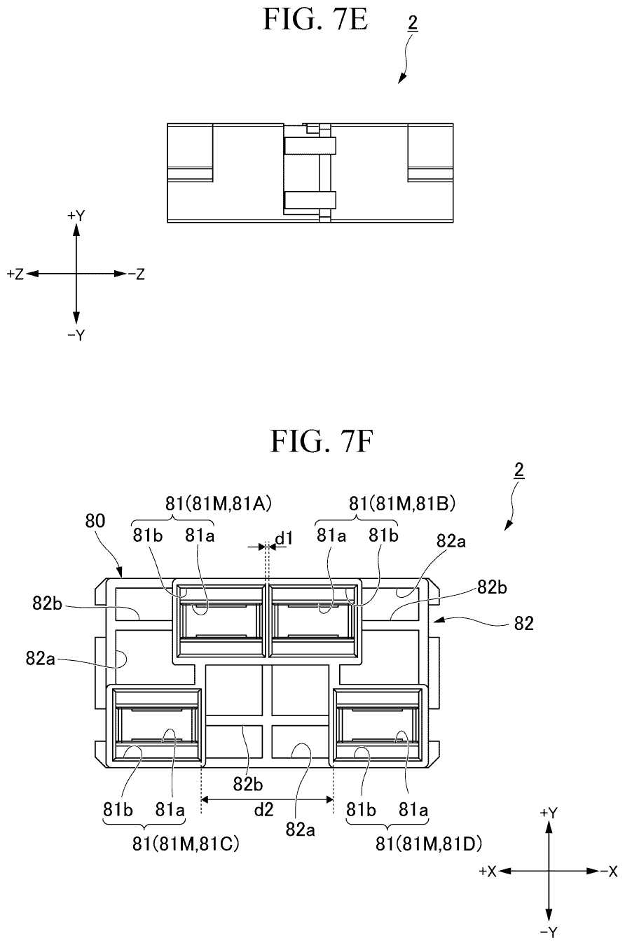

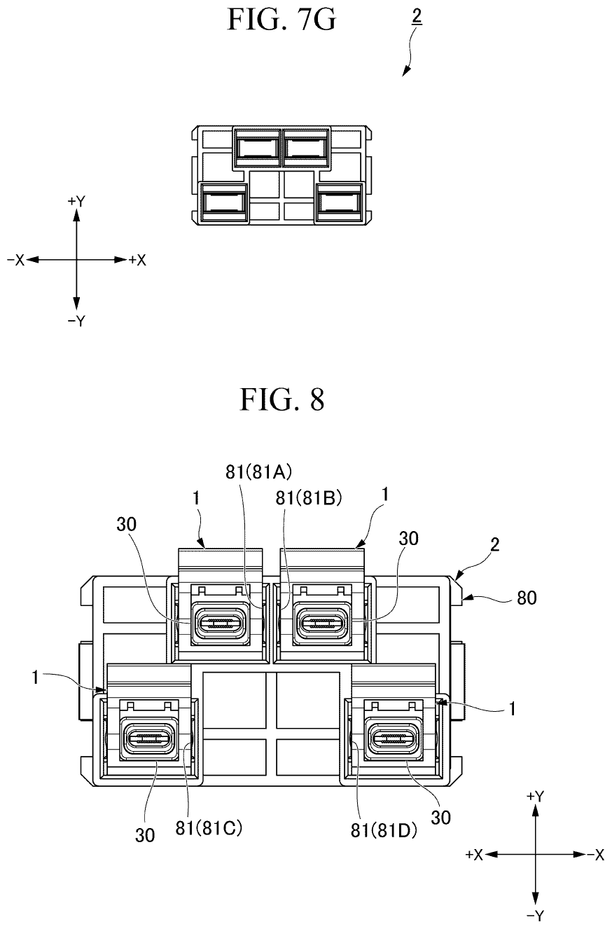

As shown in FIG. 1, the optical connection structure 100 includes a plurality of multi-fiber optical connectors 1, an adapter 2, and a clip C. A clip recessed portion 90 into which the clip C is fitted is formed in an adapter main body portion 80 (described later) of the adapter 2 (refer also to FIG. 7A). The optical connection structure 100 is used, for example, by being incorporated into an optical connection device for connecting a large number of optical fibers to each other in a data center or the like. The clip C can be used in a case of fixing the optical connection structure 100 to the device. The optical connection structure 100 may not include the adapter 2 and the clip recessed portion 90.

In the present embodiment, the optical connection structure 100 includes four male connectors 1M and four female connectors 1F. Each of the four male connectors 1M is connected to each of the four female connectors 1F by being inserted into insertion ports 81 (described later) of the adapter 2. In the present embodiment, a structural difference between the male connector 1M and the female connector 1F is only presence or absence of a guide pin 70 (described later). Hereinafter, unless otherwise specified, in a case where the multi-fiber optical connector 1 is described, the male connector 1M will be described.

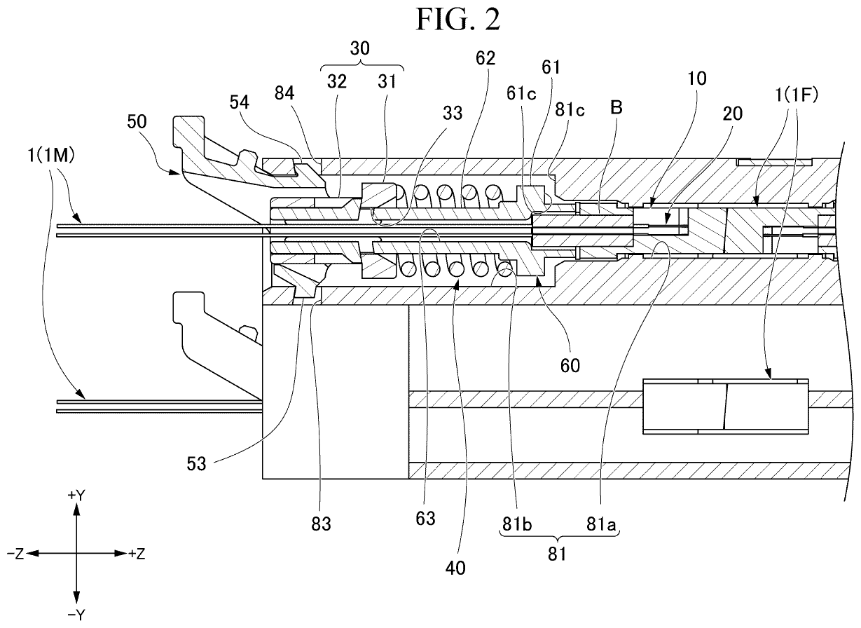

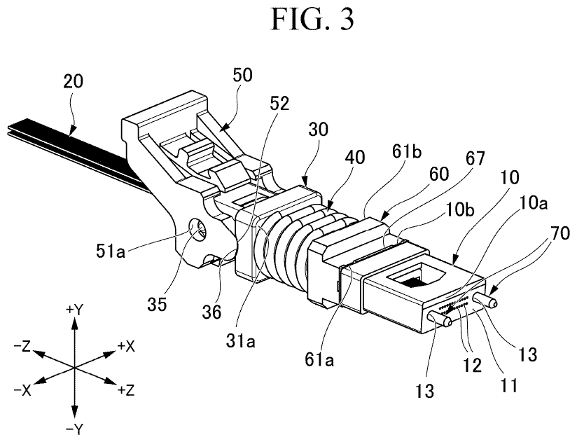

As shown in FIGS. 2 and 3, each multi-fiber optical connector 1 (male connectors 1M) includes a ferrule 10, a plurality of optical fibers 20, a first member 30, a biasing member 40, a spring push 50, a second member 60, and a pair of guide pins 70. As shown in FIG. 3, the ferrule 10 includes a connection end 10a provided with a connection end surface 11, and a base end 10b located on a side opposite to the connection end 10a. The ferrule 10 has a plurality of fiber holes 12 through which the plurality of optical fibers 20 are insertable, toward the connection end surface 11.

### (Definition of Direction)

Here, in the present embodiment, the direction in which each fiber hole 12 extends is referred to as a longitudinal direction Z. The longitudinal direction Z is also the direction in which the connection end 10a and the base end 10b of the ferrule 10 are arranged. The longitudinal direction Z is also the direction in which each male connector 1M and each female connector 1F face each other in the optical connection structure 100. One direction orthogonal to the longitudinal direction Z is referred to as a first direction X. A direction orthogonal to both the longitudinal direction Z and the first direction X is referred to as a second direction Y. The direction of the ferrule 10 (included in the male connector 1M) from the base end 10b to the connection end 10a along the longitudinal direction Z is referred to as a +Z direction, a front side, a distal end side, or a connection end side. A direction opposite to the +Z direction is referred to as a −Z direction, a rear side, or a base end side. One direction along the first direction X is referred to as a +X direction or a right side. A direction opposite to the +X direction is referred to as a −X direction or a left side. One direction along the second direction Y is referred to as a +Y direction or an upper side. A direction opposite to the +Y direction is referred to as a −Y direction or a lower side.

As shown in FIG. 3, in the present embodiment, the connection end 10a of the ferrule 10 faces the front side, and the base end 10b faces the rear side. In a case where the multi-fiber optical connector 1 is connected to another optical connector, the connection end surface 11 described above comes into contact with a connection end surface 11 of the other optical connector. That is, in the optical connection structure 100 according to the present embodiment, in a case where the male connector 1M and the female connector 1F are connected to each other, the connection end surface 11 included in the male connector 1M and the connection end surface 11 included in the female connector 1F come into contact with each other. The connection end surface 11 may be perpendicular to the longitudinal direction Z, or may be non-perpendicular to the longitudinal direction Z (refer to FIG. 2).

As shown in FIG. 3, the plurality of fiber holes 12 and a pair of guide pin holes 13 are formed in the connection end surface 11 of the ferrule 10 according to the present embodiment. The guide pin 70 is inserted through each guide pin hole 13. Each of the fiber holes 12 and the guide pin holes 13 is open to the connection end surface 11 of the ferrule 10 and penetrates the ferrule 10 in the longitudinal direction Z. The plurality of fiber holes 12 according to the present embodiment are located between the pair of guide pin holes 13 in the first direction X.

Each optical fiber 20 has a core and a cladding. Although not shown, at least a part of the optical fiber 20 may be covered with a sheath. As a material of the sheath, for example, a resin can be adopted. As shown in the example of FIG. 2, a boot B may be attached to the optical fiber 20. Each optical fiber 20 may be fixed inside each fiber hole 12 by an adhesive or the like.

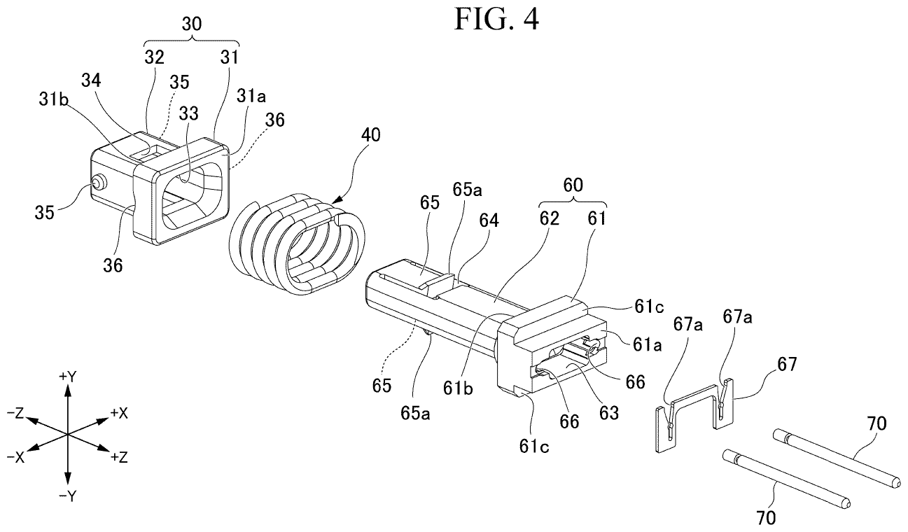

As shown in FIG. 3, the first member 30 is disposed to face the base end 10b of the ferrule 10 in the longitudinal direction Z. As shown in FIGS. 2 and 4, the first member 30 according to the present embodiment includes a large-diameter portion 31 and a small-diameter portion 32 that extends to the rear side from the large-diameter portion 31. The large-diameter portion 31 and the small-diameter portion 32 in the present embodiment are formed in a substantially rectangular shape in a cross-sectional view perpendicular to the longitudinal direction Z. The term “substantially rectangular shape” also includes chamfering or a case where the shape can be regarded as a rectangular shape by removing a manufacturing error. Each of the dimensions of the small-diameter portion 32 in the first direction X and the second direction Y is smaller than each of the dimensions of the large-diameter portion 31 in the first direction X and the second direction Y. In addition, a through-hole 33 that penetrates the large-diameter portion 31 and the small-diameter portion 32 in the longitudinal direction Z is formed in the first member 30 (refer also to FIG. 2). In other words, the first member 30 has a tubular shape.

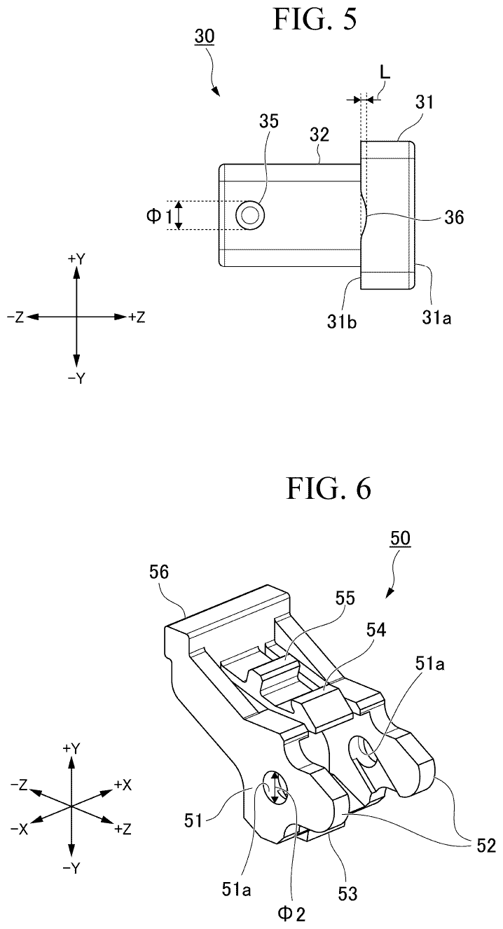

The large-diameter portion 31 includes a pressing surface 31a facing the front side and a pressed surface 31b facing the rear side. A fitting recessed portion 36 that is recessed toward the front side is formed in the pressed surface 31b. Hereinafter, for the sake of description, a distance between a front end of the fitting recessed portion 36 and the pressed surface 31b in the longitudinal direction Z may be referred to as a “recess amount L of the fitting recessed portion 36” (refer to FIG. 5). The fitting recessed portion 36 according to the present embodiment is disposed at a central position of the large-diameter portion 31 in the second direction Y.

As shown in FIG. 4, a pair of locking holes 34 that penetrate an upper wall and a lower wall of the small-diameter portion 32 in the second direction Y are formed in the first member 30 according to the present embodiment. The shape of the locking hole 34 according to the present embodiment is a rectangular shape as viewed in the second direction Y.

The first member 30 according to the present embodiment has a pair of stop pins that protrude from a side surface of the small-diameter portion 32 toward an outside in the first direction X. Each stop pin 35 according to the present embodiment is located at a rear end portion of the small-diameter portion 32. As shown in FIG. 5, the shape of each stop pin 35 is a substantially circular shape as viewed in the first direction X. The term “substantially circular shape” also includes an elliptical shape or a case where the shape can be regarded as a circular shape by removing a manufacturing error. Hereinafter, an outer diameter of the stop pin 35 may be denoted by a reference sign Φ1.

As shown in FIG. 3, the second member 60 according to the present embodiment is attached to the base end 10b of the ferrule 10. The second member 60 according to the present embodiment functions as a pin clamp. As shown in FIG. 4, the second member 60 according to the present embodiment includes a grip base 61 and an extending portion 62 that extends to the rear side from the grip base 61. Each of the grip base 61 and the extending portion 62 in the present embodiment is formed in a substantially rectangular shape in a cross-sectional view perpendicular to the longitudinal direction Z. The term “substantially rectangular shape” also includes chamfering or a case where the shape can be regarded as a rectangular shape by removing a manufacturing error. Each of the dimensions of the extending portion 62 in the first direction X and the second direction Y is smaller than each of the dimensions of the grip base 61 in the first direction X and the second direction Y. The extending portion 62 is inserted through the through-hole 33 of the first member 30 (refer also to FIG. 2). In addition, a fiber insertion hole 63 that penetrates the grip base 61 and the extending portion 62 in the longitudinal direction Z is formed in the second member 60 (refer also to FIG. 2). In other words, the second member 60 has a tubular shape. The plurality of optical fibers 20 are inserted through the fiber insertion hole 63.

As shown in FIG. 4, the grip base 61 includes a pressing surface 61a facing the front side, a biased surface 61b facing the rear side, and a pair of first facing surfaces 61c facing the front side. The pressing surface 61a is in contact with the base end 10b of the ferrule 10 via an auxiliary tool 67 (refer to FIG. 3). As shown in FIG. 4, in the second direction Y, the pressing surface 61a is located between the pair of first facing surfaces 61c. In addition, each first facing surface 61c is located in the rear side of the pressing surface 61a.

An opening 64 and a locking claw 65 are formed on each of an upper wall and a lower wall of the extending portion 62 according to the present embodiment. The shape of the opening 64 according to the present embodiment is a C-shape that is open toward the rear side as viewed in the second direction Y. The locking claw 65 is surrounded by the opening 64 as viewed in the second direction Y. The locking claw 65 is elastically bendable in the second direction Y with a rear end portion of the locking claw 65 as a base end. A locking protrusion 65a that protrudes toward an outside in the second direction Y is provided at a front end (distal end) of each locking claw 65.

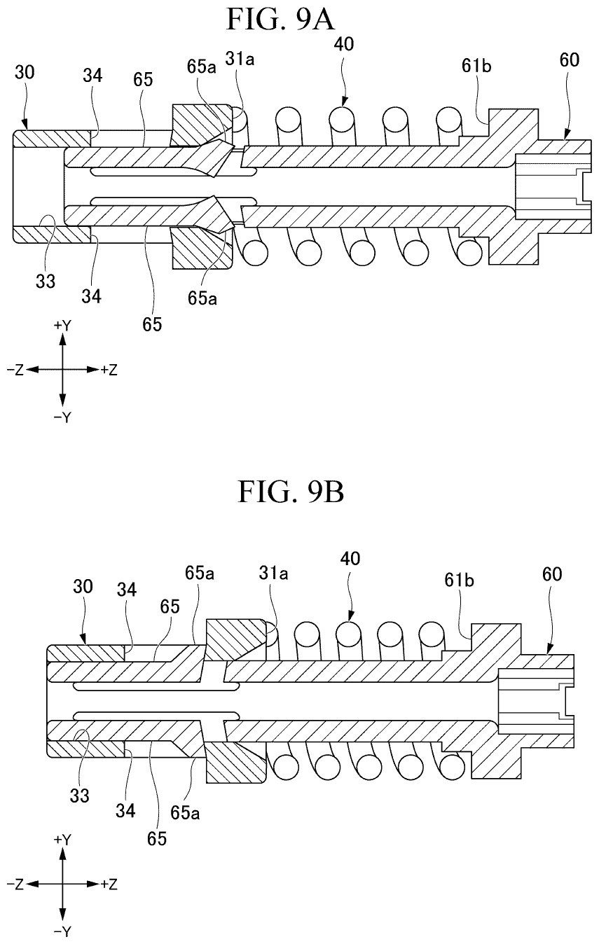

As shown in FIG. 3, the biasing member 40 is disposed between the first member 30 and the ferrule 10 in the longitudinal direction Z. In the present embodiment, more specifically, the biasing member 40 is interposed between the pressing surface 31a of the first member 30 and the biased surface 61b of the second member 60 in the longitudinal direction Z. The biasing member 40 has a function of biasing the ferrule 10 toward the connection end 10a (toward the front side) via the pressing surface 61a of the second member 60 by being compressed between the pressing surface 31a and the biased surface 61b. As the biasing member 40, for example, a coil spring can be used. As details will be described below, in a state in which the extending portion 62 of the second member 60 is inserted through the through-hole 33 of the first member 30, each locking protrusion 65a is inserted into the locking hole 34 and is locked to a front end of the locking hole 34 (refer also to FIGS. 9A and 9B). As a result, the second member 60 holds the first member 30 in a state in which the first member 30 presses the biasing member 40 and the biasing member 40 is compressed. That is, the first member 30 functions as a holding member that holds the biasing member 40 in the second member 60.

The second member 60 according to the present embodiment is a so-called pin clamp, and a pair of guide pin grip holes 66 for gripping the pair of guide pins 70 are formed. Each guide pin grip hole 66 is open to the pressing surface 61a of the grip base 61. The guide pin grip hole 66 according to the present embodiment is open toward the inside in the first direction X and communicates with the fiber insertion hole 63. In addition, the auxiliary tool 67 is attached to the pressing surface 61a of the grip base 61 according to the present embodiment. A pair of slits 67a that extends in the second direction Y is formed in the auxiliary tool 67. Each guide pin 70 is gripped by the second member 60 by being inserted through the slit 67a and by being inserted into the guide pin grip hole 66. The guide pin grip hole 66 may not communicate with the fiber insertion hole 63 and may be open only to the pressing surface 61a. In this case, the auxiliary tool 67 may not be attached to the grip base 61. In addition, in a case where the first member 30 can be held in a state in which the first member 30 presses the biasing member 40, the second member 60 may not be a pin clamp.

As shown in FIG. 3, the spring push 50 according to the present embodiment is disposed in the rear side of the first member 30. As shown in FIG. 6, the spring push 50 according to the present embodiment includes a rotation base 51, a pressing protrusion 52, a support shaft protrusion 53, a fixing protrusion 54, an auxiliary protrusion 55, and a handle 56. The handle 56 extends to the rear side from the rotation base 51.

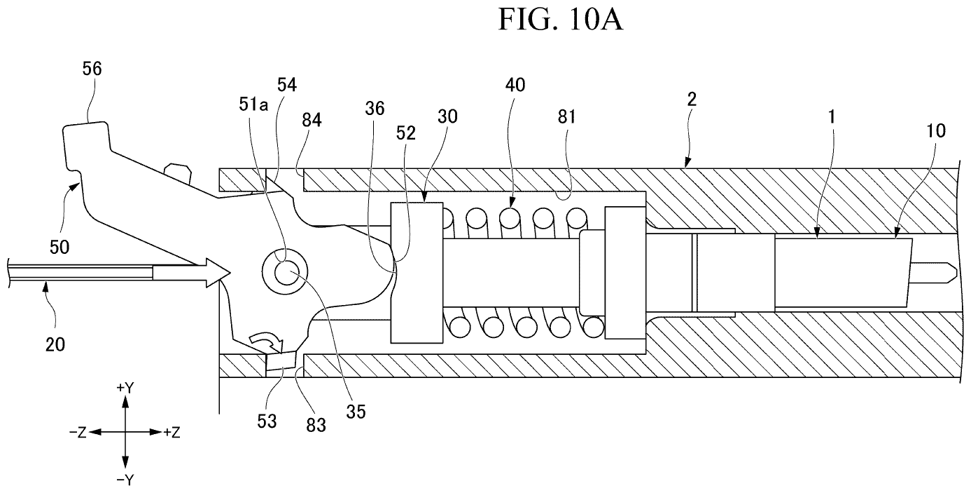

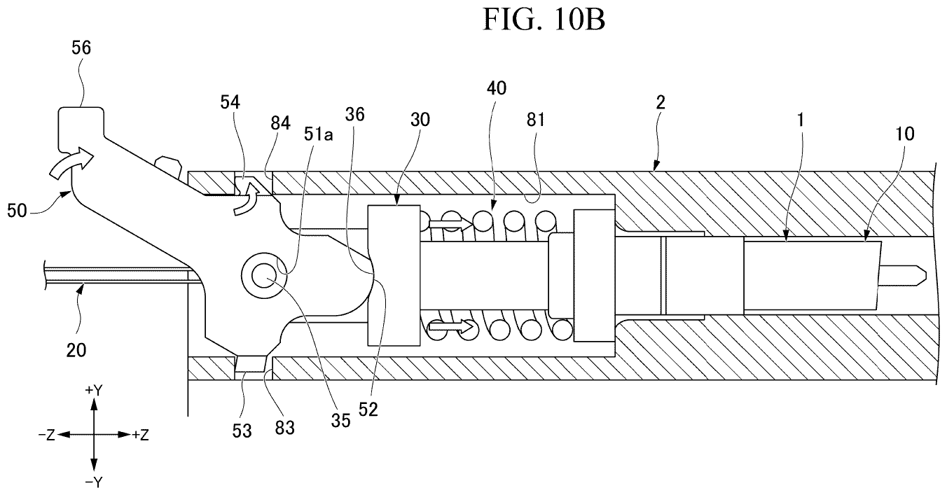

The support shaft protrusion 53 according to the present embodiment protrudes toward the lower side from the rotation base 51. As shown in FIG. 2, the support shaft protrusion 53 is inserted into the support shaft hole 83 formed in the adapter 2. As details will be described below, the support shaft protrusion 53 is inserted into the support shaft hole 83, so that the spring push 50 can perform rotational movement about the support shaft protrusion 53 as a support shaft (refer also to FIG. 10A).

As shown in FIG. 6, the pressing protrusion 52 protrudes toward the front side from the rotation base 51. As shown in FIG. 3, the pressing protrusion 52 is fitted into the fitting recessed portion 36 of the first member 30. Since the spring push 50 performs the above-described rotational movement, the pressing protrusion 52 presses the first member 30 toward the front side (refer also to FIG. 10A). That is, the spring push 50 presses the first member 30 toward the front side via the rotational movement.

As shown in FIG. 6, the fixing protrusion 54 according to the present embodiment is formed on the handle 56. As shown in FIG. 2, the fixing protrusion 54 is inserted into a fixing hole 84 formed in the adapter 2. As details will be described below, the fixing protrusion 54 is inserted into the fixing hole 84, so that the spring push 50 is fixed to the adapter 2 in a state in which the first member 30 is pressed (refer also to FIG. 10B).

As shown in FIG. 6, a pair of stop holes 51a that penetrate the rotation base 51 in the first direction X are formed in the spring push 50 according to the present embodiment. As shown in FIG. 3, the stop pin 35 of the first member 30 is inserted into each stop hole 51a. The stop pin 35 is inserted into the stop hole 51a, so that the spring push 50 is prevented from falling off from the first member 30. In addition, the shape of each stop hole 51a according to the present embodiment is a substantially circular shape as viewed in the first direction X. The term “substantially circular shape” also includes a case where the shape can be regarded as a circular shape by removing a manufacturing error. Hereinafter, for the sake of description, an inner diameter of the stop hole 51a may be denoted by a reference sign Φ2. The inner diameter Φ2 of the stop hole 51a is equal to or greater than the outer diameter Φ1 of the stop pin 35.

In the present embodiment, the recess amount L (refer to FIG. 5) of the fitting recessed portion 36 is larger than a difference between the inner diameter Φ2 of the stop hole 51a and the outer diameter Φ1 of the stop pin 35. With this configuration, the pressing protrusion 52 is prevented from falling off from the fitting recessed portion 36. That is, the first member 30 also functions as a holding member that holds the spring push 50.

As shown in FIGS. 7A to 7H, the adapter 2 according to the present embodiment includes the adapter main body portion 80, the plurality of insertion ports 81, and a non-insertion portion 82. The insertion port 81 is a hole formed in the adapter main body portion 80, and the above-described multi-fiber optical connector 1 (male connector 1M or female connector 1F) is inserted thereinto. The non-insertion portion 82 is a portion of the adapter main body portion 80 in which the insertion port 81 is not formed.

As shown in FIG. 7A, four male insertion ports 81M, into each of which each of the male connectors 1M is inserted, and four female insertion ports 81F, into which the female connectors 1F are inserted, are formed in the adapter main body portion 80 according to the present embodiment. The four male insertion ports 81M and the four female insertion ports 81F correspond to each other one-to-one, and face each other in the longitudinal direction Z. In the present embodiment, a structure of the male insertion port 81M and a structure of the female insertion port 81F are basically the same. Hereinafter, unless otherwise specified, in a case where the insertion port 81 is described, the male insertion port 81M will be described. In addition, for the sake of facilitating the following description, each of the four male insertion ports 81M may be referred to as a first insertion port 81A, a second insertion port 81B, a third insertion port 81C, and a fourth insertion port 81D (refer to FIG. 7F). The four insertion ports 81A to 81D according to the present embodiment are disposed symmetrically in the first direction X (refer to FIG. 7F).

As shown in FIG. 2, each insertion port 81 includes a small-diameter portion 81a into which the ferrule 10 is inserted, and a large-diameter portion 81b that is a hole that communicates with a rear end of the small-diameter portion 81a. Each of the dimensions of the large-diameter portion 81b in the first direction X and the second direction Y is larger than each of the dimensions of the small-diameter portion 81a in the first direction X and the second direction Y. A second facing surface 81c facing the rear side is provided at a front end of the large-diameter portion 81b. In a case where the multi-fiber optical connector 1 is inserted into the insertion port 81, the first facing surface 61c and the second facing surface 81c of the multi-fiber optical connector 1 face each other in the longitudinal direction Z.

The support shaft hole 83 and the fixing hole 84 described above are formed in each insertion ports 81. The support shaft hole 83 according to the present embodiment is open on a lower surface of the insertion port 81. The shape of the insertion port 81 corresponds to the shape of the support shaft protrusion 53. The fixing hole 84 according to the present embodiment is open on an upper surface of the insertion port 81. The shape of the fixing hole 84 corresponds to the shape of the fixing protrusion 54.

As shown in FIG. 7F, in the present embodiment, the first insertion port 81A and the second insertion port 81B are disposed side by side in the first direction X. The third insertion port 81C and the fourth insertion port 81D are disposed side by side in the first direction X.

In addition, positions of the third insertion port 81C and the fourth insertion port 81D are different from positions of the first insertion port 81A and the second insertion port 81B in the second direction Y. In the shown example, the third insertion port 81C and the fourth insertion port 81D are located in the lower side of the first insertion port 81A and the second insertion port 81B. In addition, the third insertion port 81C and the fourth insertion port 81D are disposed while being shifted to the outside in the first direction X with respect to the first insertion port 81A and the second insertion port 81B as viewed in the longitudinal direction Z. In other words, a distance d2 between the third insertion port 81C and the fourth insertion port 81D in the first direction X is larger than a distance d1 between the first insertion port 81A and the second insertion port 81B in the first direction X.

Here, as shown in FIG. 8, the first members 30, each of which is provided in each of the four multi-fiber optical connectors 1, may not overlap with each other in the second direction Y in a state in which the multi-fiber optical connectors 1 (male connector 1M) are inserted into the four insertion ports 81A to 81C. In other words, in the insertion state, the positions of the four insertion ports 81A to 81D (the difference between the distances d1 and d2 described above) may be set such that the four first members 30 do not overlap with each other in the second direction Y.

In addition, as shown in FIG. 7F, the non-insertion portion 82 of the adapter main body portion 80 may have a mesh structure. That is, the non-insertion portion 82 may include a plurality of through-holes 82a that penetrate the adapter main body portion 80 in the longitudinal direction Z, and a plurality of column-beam portions 82b that are disposed in the through-holes 82a. Each column-beam portion 82b according to the present embodiment extends in the first direction X or the second direction Y and connects inner surfaces of the through-holes 82a to each other. Since the non-insertion portion 82 includes the through-hole 82a, the air permeability of the optical connection structure 100 is improved. In other words, the heat flow in the optical connection device is less likely to be inhibited by the optical connection structure 100. In addition, since the plurality of column-beam portions 82b are disposed in the through-hole 82a, the mechanical strength of the adapter 2 can be improved. The number, the direction, and the shape of the column-beam portion 82b can be appropriately changed.

Next, actions of the multi-fiber optical connector 1 and the optical connection structure 100 configured as described above will be described.

In a case of manufacturing (assembling) the optical connection structure 100, for example, an assembling step of assembling the multi-fiber optical connector 1 and an inserting step of inserting the assembled multi-fiber optical connector 1 into the insertion port 81 of the adapter 2 are performed. Among the two steps, the assembling step may be performed, for example, in a factory or the like in which the multi-fiber optical connector 1 is manufactured. On the other hand, the inserting step may be performed by, for example, a user who uses the optical connection structure 100. Hereinafter, each of the assembling step and the inserting step will be described.

The assembling step includes an interposing step of interposing the biasing member 40 between the first member 30 and the second member 60. More specifically, first, the extending portion 62 of the second member 60 is inserted into the biasing member 40, and a front end of the biasing member 40 comes into contact with the biased surface 61b of the second member 60 (refer to FIG. 9A). Next, the first member 30 is attached to the second member 60 from the rear side such that the extending portion 62 is inserted into the through-hole 33 of the first member 30. As the first member 30 moves forward, as shown in FIG. 9A, the locking claw 65 is bent inward in the second direction Y, and the pressing surface 31a of the first member 30 comes into contact with a rear end of the biasing member 40 to compress the biasing member 40. As the first member 30 further moves forward, as shown in FIG. 9B, the locking protrusion 65a is inserted into the locking hole 34, and the first member 30 is locked to the second member 60. As a result, the second member 60 holds the first member 30 in a state in which the first member 30 presses the biasing member 40 and the biasing member 40 is compressed.

In addition to the above-described interposing step, for example, a ferrule attaching step of attaching the ferrule 10 to the second member 60, a spring push attaching step of attaching the spring push 50 to the first member 30, an inserting-through step of inserting the optical fiber 20 into the ferrule 10, the first member 30, the spring push 50, and the second member 60, and the like are performed, thereby completing the assembling step. An order in which the interposing step, the ferrule attaching step, the spring push attaching step, and the inserting-through step are performed can be appropriately changed.

Next, the inserting step will be described. First, as shown in FIG. 10A, the user inserts the support shaft protrusion 53 of the spring push 50 into the support shaft hole 83 of the adapter 2. Next, for example, by gripping and lifting the handle 56, the user causes the spring push 50 to perform rotational movement about the support shaft protrusion 53 as the support shaft (refer to FIG. 10B). More specifically, the user lifts the handle 56, whereby the spring push 50 performs the rotational movement having a rotation axis parallel to the first direction X. In this case, the pressing protrusion 52 of the spring push 50 and the fitting recessed portion 36 of the first member 30 slide on each other, and the pressing protrusion 52 presses the first member 30 toward the front side. That is, the rotational movement of the spring push 50 is converted into the linear movement of the first member 30 in the longitudinal direction Z. The spring push 50 presses the first member 30 toward the front side, so that the biasing member 40 is further compressed as compared with a case where the assembling step is completed. In a case where the user continues the rotation of the spring push 50 (lifting of the handle 56), the fixing protrusion 54 of the spring push 50 is inserted into the fixing hole 84 of the adapter 2. As a result, the spring push 50 and the multi-fiber optical connector 1 are fixed in the insertion port 81 of the adapter 2 in a state in which the spring push 50 presses the first member 30.

By performing the above-described inserting step for all the multi-fiber optical connectors 1, the manufacture (assembly) of the optical connection structure 100, that is, the connection between each male connector 1M and each female connector 1F is completed.

As described above, in the multi-fiber optical connector 1 and the optical connection structure 100 according to the present embodiment, the first member 30 is pressed by using the rotational movement of the spring push 50. Therefore, by the lever principle, a force to be applied to the spring push 50 in a case where the user connects the multi-fiber optical connectors 1 to each other can be reduced. In addition, since the multi-fiber optical connector 1 includes the second member 60, the biasing member 40 can be compressed in two steps of the assembling step (interposing step) and the inserting step. Therefore, it is possible to reduce an amount by which the user needs to rotate the spring push 50 in the inserting step.

In addition, the multi-fiber optical connector 1 according to the present embodiment has a structure in which the spring push 50 presses the biasing member 40 via the first member 30. More specifically, a structure in which the rotational movement of the spring push 50 is converted into the linear movement of the first member 30 to press the biasing member 40 is adopted. With this configuration, it is possible to reduce the buckling of the biasing member 40 as compared with a case where the spring push 50 that performs the rotational movement is directly in contact with the biasing member 40, for example.

In addition, in the multi-fiber optical connector 1 according to the present embodiment, since the biasing member 40 is disposed on an outside of the extending portion 62 of the second member 60, the contact between the biasing member 40 and the optical fiber 20 is suppressed. As a result, in the inserting step, a case where the biasing member 40 and the optical fiber 20 are unexpectedly brought into contact with each other and damage to the optical fiber 20 occurs is suppressed.

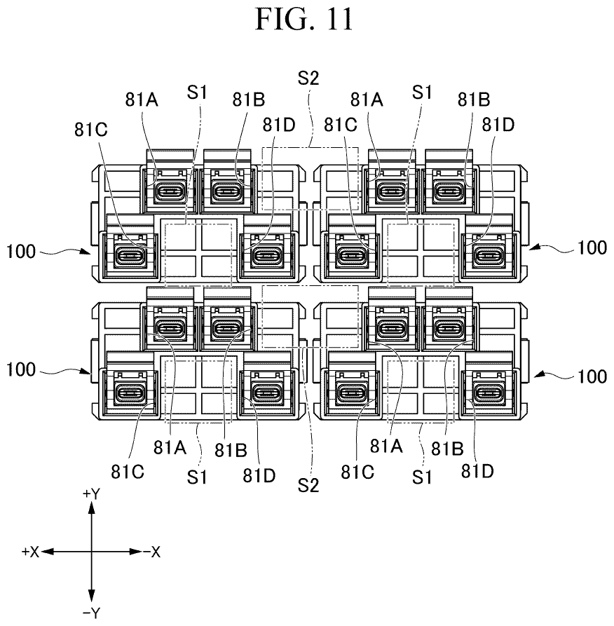

In addition, as described above, the third insertion port 81C and the fourth insertion port 81D according to the present embodiment are disposed while being shifted to the outside in the first direction X with respect to the first insertion port 81A and the second insertion port 81B. Therefore, the user can easily touch the spring push 50 to operate (rotate) the spring push 50 by inserting a finger into a space S1 (refer to FIG. 11) between the third insertion port 81C and the fourth insertion port 81D. In addition, as shown in FIG. 11, even in a case where the optical connection structures 100 according to the present embodiment are two-dimensionally integrated in the first direction X and the second direction Y, the user can easily operate the spring push 50. More specifically, the user can operate the spring push 50 by inserting a finger into the above-described space S1 or a space S2 shown in FIG. 11. The space S2 is a space between the second insertion port 81B included in a certain optical connection structure 100 and the first insertion port 81A included in an optical connection structure 100 adjacent to the certain optical connection structure 100 (refer to FIG. 11).

As described above, the multi-fiber optical connector 1 according to the present embodiment is inserted into the adapter 2, the multi-fiber optical connector 1 includes the ferrule 10 that includes the connection end 10a provided with the connection end surface 11, the base end 10b located on the side opposite to the connection end 10a, and the plurality of fiber holes 12 through which the plurality of optical fibers 20 are insertable toward the connection end surface 11; the first member 30 that is disposed to face the base end 10b of the ferrule 10 in the longitudinal direction Z; the biasing member 40 that is disposed between the first member 30 and the ferrule 10 in the longitudinal direction Z, and biases the ferrule 10 toward the front side (connection end 10a); and the spring push 50 that presses the first member 30 toward the front side (connection end 10a) the via rotational movement.

With this configuration, by the lever principle, a force required in a case of connecting the multi-fiber optical connectors 1 (male connector 1M and female connector 1F) to each other can be reduced.

In addition, the multi-fiber optical connector 1 according to the present embodiment further includes the second member 60 that holds the first member 30 in a state in which the first member 30 presses the biasing member 40. With this configuration, it is possible to reduce an amount by which the user needs to rotate the spring push 50 in a case of inserting the multi-fiber optical connector 1 into the adapter 2 to connect the multi-fiber optical connectors 1 to each other, and to reduce a burden on the user.

In addition, the stop pin 35 is formed in the first member 30, and the stop hole 51a is formed in the spring push 50, and the stop pin 35 is inserted into the stop hole 51a, so that the spring push 50 is held by the first member 30. With this configuration, it is possible to prevent the spring push 50 from falling off from the first member 30.

In addition, the spring push 50 includes the pressing protrusion 52 that is in contact with the first member 30 and presses the first member 30, a fitting recessed portion 36 into which the pressing protrusion 52 is fitted is formed in the first member 30, and the recess amount L of the fitting recessed portion 36 is larger than the difference between the inner diameter Φ2 of the stop hole 51a and the outer diameter Φ1 of the stop pin 35. With this configuration, the pressing protrusion 52 is prevented from falling off from the fitting recessed portion 36.

In addition, the spring push 50 includes the support shaft protrusion 53, and the support shaft protrusion 53 is inserted into the support shaft hole 83 formed in the adapter 2 and serves as a support shaft for the above-described rotational movement. With this configuration, it is possible to cause the spring push 50 to stably perform the rotational movement.

In addition, the spring push 50 includes the fixing protrusion 54, and the fixing protrusion 54 is inserted into the fixing hole 84 formed in the adapter 2 and fixes the spring push 50 to the adapter 2 in a state in which the spring push 50 presses the first member 30. With this configuration, it is possible to fix the multi-fiber optical connector 1 and the spring push 50 in the adapter 2 in a state in which the biasing member 40 is compressed.

In addition, the optical connection structure 100 according to the present embodiment includes at least four multi-fiber optical connectors 1 and the adapter 2 in which at least four insertion ports 81, into each of which each of the multi-fiber optical connectors 1 is inserted, are formed, in which the first insertion port 81A and the second insertion port 81B are disposed side by side in the first direction X, the positions of the third insertion port 81C and the fourth insertion port 81D are different from the positions of the first insertion port 81A and the second insertion port 81B in the second direction Y, and the third insertion port 81C and the fourth insertion port 81D are disposed while being shifted to the outside in the first direction X with respect to the first insertion port 81A and the second insertion port 81B as viewed in the longitudinal direction Z. With this configuration, the user can easily operate the spring push 50 by inserting a finger into the space S1 between the third insertion port 81C and the fourth insertion port 81D.

In addition, the first members 30, each of which is provided in each of the four multi-fiber optical connectors 1, do not overlap with each other in the second direction Y in a state in which the four multi-fiber optical connectors 1 are inserted into the four insertion ports 81A to 81D. With this configuration, the space S1 is further increased, and the operation of the spring push 50 is further facilitated.

It should be noted that the technical scope of the present invention is not limited to the above-described embodiment, and various modifications can be made without departing from the spirit of the present invention.

For example, the support shaft protrusion 53 of the spring push 50 protrudes toward the lower side from the rotation base 51 in the embodiment, but the support shaft protrusion 53 may protrude toward the upper side from the rotation base 51. In addition, a rotation axis of the rotational movement of the spring push 50 may not be parallel to the first direction X, and may be parallel to another direction perpendicular to the longitudinal direction Z (for example, the second direction Y). In this case, the direction in which the support shaft protrusion 53 protrudes from the rotation base 51, a protruding direction of the stop pin 35, and a penetrating direction of the stop hole 51a may be changed according to the direction of the rotational movement. In addition, in a case where the spring push 50 can be fixed to the adapter 2, the position and the direction of the fixing protrusion 54 can be appropriately changed.

In addition, in the embodiment, the stop pin 35 is formed in the first member 30, and the stop hole 51a is formed in the spring push 50, but the stop pin 35 may be formed in the spring push 50, and the stop hole 51a may be formed in the first member 30.

In addition, the multi-fiber optical connector 1 may not include the second member 60. In this case, a configuration in which the front end of the biasing member is in contact with the base end 10b of the ferrule 10 and the biasing member 40 directly biases the ferrule 10 may be adopted.

In addition, the number of the insertion ports 81 (male insertion ports 81M) provided in the adapter 2 can be appropriately changed as long as the number thereof is four or more.

In addition, without departing from the spirit of the present invention, it is possible to appropriately replace the constituent elements in the above-described embodiment with well-known constituent elements, and the above-described embodiment and modification examples may be appropriately combined.

### REFERENCE SIGNS LIST

100: Optical connection structure
1: Multi-fiber optical connector
2: Adapter
10: Ferrule
10a: Connection end
10b: Base end
11: Connection end surface
12: Fiber hole
20: Optical fiber
30: First member
34: Locking hole
35: Stop pin
36: Fitting recessed portion
40: Biasing member
50: Spring push
51a: Stop hole
52: Pressing protrusion
53: Support shaft protrusion
54: Fixing protrusion
81: Insertion port
81A: First insertion port
81B: Second insertion port
81C: Third insertion port
81D: Fourth insertion port
83: Support shaft hole
84: Fixing hole
Z: Longitudinal direction
X: First direction
Y: Second direction

1. A multi-fiber optical connector comprising:
a ferrule that includes a connection end provided with a connection end surface, a base end located on a side opposite to the connection end, and a plurality of fiber holes through which a plurality of optical fibers are insertable toward the connection end surface;
a first member that is disposed to face the base end of the ferrule in a longitudinal direction in which the fiber holes extend;
a biasing member that is disposed between the first member and the ferrule in the longitudinal direction, and biases the ferrule toward the connection end; and
a spring push that presses the first member toward the connection end via rotational movement.

2. The multi-fiber optical connector according to claim 1, further comprising:
a second member that holds the first member in a state in which the first member presses the biasing member.

3. The multi-fiber optical connector according to claim 1,
wherein a stop pin is formed in the first member or the spring push,
a stop hole is formed in the first member or the spring push which the stop pin is not formed, and
the stop pin is inserted into the stop hole, so that the spring push is held by the first member.

4. The multi-fiber optical connector according to claim 3,
wherein the spring push includes a pressing protrusion that is in contact with the first member and presses the first member,
a fitting recessed portion into which the pressing protrusion is fitted is formed in the first member, and
a recess amount of the fitting recessed portion is larger than a difference between an inner diameter of the stop hole and an outer diameter of the stop pin.

5. A multi-fiber optical connector that is inserted into an adapter, the multi-fiber optical connector comprising:
a ferrule that includes a connection end provided with a connection end surface, a base end located on a side opposite to the connection end, and a plurality of fiber holes through which a plurality of optical fibers are insertable toward the connection end surface;
a first member that is disposed to face the base end of the ferrule in a longitudinal direction in which the fiber holes extend;
a biasing member that is disposed between the first member and the ferrule in the longitudinal direction, and biases the ferrule toward the connection end; and
a spring push that presses the first member toward the connection end via rotational movement.

6. The multi-fiber optical connector according to claim 5,
wherein the spring push includes a support shaft protrusion, and
the support shaft protrusion is inserted into a support shaft hole formed in the adapter and serves as a support shaft for the rotational movement.

7. The multi-fiber optical connector according to claim 5,
wherein the spring push includes a fixing protrusion, and
the fixing protrusion is inserted into a fixing hole formed in the adapter and fixes the spring push to the adapter in a state in which the spring push presses the first member.

8. An optical connection structure comprising:
at least four multi-fiber optical connectors that include the multi-fiber optical connector according to claim 1; and
an adapter in which at least four insertion ports, into each of which each of the multi-fiber optical connectors is inserted, are formed,
wherein the four insertion ports include a first insertion port, a second insertion port, a third insertion port, and a fourth insertion port,
the first insertion port and the second insertion port are disposed side by side in a first direction orthogonal to the longitudinal direction,
positions of the third insertion port and the fourth insertion port are different from positions of the first insertion port and the second insertion port in a second direction orthogonal to both the longitudinal direction and the first direction, and
the third insertion port and the fourth insertion port are disposed while being shifted to an outside in the first direction with respect to the first insertion port and the second insertion port as viewed in the longitudinal direction.

9. The optical connection structure according to claim 8,
wherein the first member provided in each of the four multi-fiber optical connectors, does not overlap with each other in the second direction in a state in which the four multi-fiber optical connectors are inserted into the four insertion ports.
